(19) United States
(12) Patent Application Publication
(10) Pub. No.: US 2025/0075720 A1
(43) Pub. Date: Mar. 6, 2025

(54) CIRCULAR LOCKING SEAL

(71) Applicant: HYDRIL COMPANY, Houston, TX (US)

(72) Inventors: Nishikant Raje, Houston, TX (US); Adam Hasskamp, Houston, TX (US); Andrew Tate, Katy, TX (US); Travis Stratton, Houston, TX (US)

(73) Assignee: HYDRIL COMPANY, Houston, TX (US)

(21) Appl. No.: 18/824,414

(22) Filed: Sep. 4, 2024

Related U.S. Application Data
(60) Provisional application No. 63/580,615, filed on Sep. 5, 2023.

(51) Int. Cl. F16B 7/18

(52) U.S. Cl. CPC F16B 7/18

(57) ABSTRACT

A threaded connection includes a first tubular member comprising a convex circular sealing surface with a first seal radius and a second tubular member comprising a primary concave circular sealing surface with a second seal radius. The first seal radius and second seal radius are preferably different, with the second seal radius more preferably being larger than the first seal radius. The second tubular member may also comprise a second concave circular surface with a third radius that is smaller than the second seal radius. The second tubular member may also comprise a frontside angled surface forming an angle as measured from the longitudinal axis of the connection.

### TECHNICAL FIELD

The present disclosure relates generally to threaded connections and, more particularly, to a connection with a first member having a concave circular sealing surface and a second member having a convex circular sealing surface, wherein the two circular sealing surfaces may have different radii.

### BACKGROUND

This section is intended to introduce various aspects of art that may be related to various aspects of the present techniques, which are described and/or claimed below. This discussion is believed to be helpful in providing background information to facilitate a better understanding of the various aspects of the present disclosure. Accordingly, it should be understood that these statements are to be read in this light, and not as admissions of prior art. The following descriptions and examples are not admitted to be prior art by virtue of their inclusion in this section.

The oil and gas industry is drilling upstream production wells of increasing depth and complexity to find and produce raw hydrocarbons. The industry routinely uses steel pipe, considered an Oil Country Tubular Good (OCTG) to protect the borehole (i.e., casing) and to control the fluids produced within the pipe (i.e., tubing). Such pipe, including casing and tubing, are made and transported in relatively short segments and installed in the borehole one segment at a time, with each segment being connected to the next. As the search for oil and gas has driven companies to drill deeper wells, pipes may be subject to increased complexity and magnitude of forces throughout their lifespans downhole. Industry demands have grown for casing, tubing, and connectors having increased tensile and pressure strengths. Furthermore, the developing area of deviated and horizontal wells have exacerbated this trend, further adding increased torsional loads as another requirement for casing and tubing connectors.

Connectors have been designed with varying thread, shoulder, and seal configurations. For example, two general connector thread configurations include a threaded and coupled connector and an integral connector. A threaded and coupled connector includes a pin (i.e., a male threaded end) machined on relatively long joints of pipe and joined by the box (i.e., a female threaded end) machined on a relatively short coupling. An integral connector includes a pin threaded on a full-length pipe connected to a box threaded on another full-length pipe, and pin and box ends may be threaded onto opposite sides of each full-length pipe segment so that each segment may be connected for a length of a borehole. One type of shoulder and seal combination includes a center shoulder seal, which includes a sealing section in a connection disposed between at least two threaded portions. The sealing section of a pin or box may have direct contact with the sealing section of another pin or box and may function to prevent the passage of liquid or gas across the threads of the assembled connection. As industry demands connectors with increasingly high tensile strength, pressure strength, and torque, etc., the general features of connectors may be further designed and engineered to meet downhole performance criteria.

For threaded connections using integral connectors, one common design involves the use of a torque shoulder at the interface between the pin member and the box member. For example, U.S. Pat. No. 10,006,569 discloses a threaded connection comprising a pin torque shoulder. This type of connection has a determinate final make-up position. Thus, when the pin and box are made up together, the final relative position will be the point at which the torque shoulder of the pin has made contact with the corresponding surface of the box. At that point, although additional torque may be applied, the relative axial position of the pin and box will not significantly change. Accordingly, the location of the sealing surfaces—elements 24 and 124 in U.S. Pat. No. 10,006,569—are known in advance with some degree of certainty.

Another type of threaded connection does not include a torque shoulder and thus has an indeterminate make-up position. Indeterminate make-up designs are common in connections that use wedge threads, a type of threadform well known to those of ordinary skill in the art. For this type of connection, the relative position of the pin member and box member will generally vary more during make-up for a given torque range to be applied than for connections having a positive-stop torque shoulder. When this happens, it can be difficult to maintain a robust seal because it is not known in advance which portions of the pin member and box member will be in contact with each other at final make-up. Accordingly, ensuring a reliable connection between the sealing surfaces of the pin member and the and box member has historically presented challenges for designers of connections having an indeterminate make-up position.

What is needed is a combination of sealing surfaces that will create a robust seal over a range of relative axial positions. preferably while providing a smooth and balanced pressure profile during the loading cycles.

### SUMMARY

In one embodiment, a threaded connection comprises a first tubular member comprising a convex circular sealing surface with a first seal radius and a second tubular member comprising a first concave circular sealing surface with a second seal radius, wherein the first seal radius is different from the second seal radius.

In another embodiment, the second seal radius is larger than the first seal radius.

In another embodiment, the ratio between the second seal radius and the first seal radius is greater than 1.0 and less than 3.0.

In another embodiment, the ratio between the second seal radius and the first seal radius is between 2.0 and 3.0.

In another embodiment, the difference between the second seal radius and the first seal radius is between approximately 0.4 inches and approximately 1.0 inches.

In another embodiment, the difference between the second seal radius and the first seal radius is approximately 0.85 inches.

In another embodiment, the second tubular member further comprises a second concave circular surface with a third radius.

In another embodiment, the second seal radius is larger than the third radius.

In another embodiment, the first seal radius is larger than the third radius.

In another embodiment, the second tubular member further comprises a substantially planar surface that is axially separate from the first concave circular sealing surface and angled with reference to a central longitudinal axis of the connection.

In another embodiment, the angle between the substantially planar surface and the central longitudinal axis is between 6° and 10°.

In another embodiment, the first tubular member and second tubular member comprise wedge threads.

In another embodiment, the second tubular member further comprises a transition region axially located between the substantially planar surface and the first concave circular sealing surface.

In another embodiment, the transition region comprises a substantially convex surface.

In another embodiment, the substantially convex surface comprises a radially innermost point at a first radial distance from the central longitudinal axis.

In another embodiment, the first radial distance is less than the radial distance from the central longitudinal axis to any point within the first concave circular sealing surface.

In another embodiment, the first tubular member comprises a pin member and the second tubular member comprises a box member.

In another embodiment, the first tubular member comprises a pin member comprising a convex circular sealing surface with a first seal radius and the second tubular member comprises a box member comprising a first concave circular sealing surface with a second seal radius.

In another embodiment, the first tubular member comprises a box member and the second tubular member comprises a pin member.

In another embodiment, the first tubular member is a pin member and the second tubular member is a box member.

It will be clear to the skilled person that the present invention may include any combination of the above-described embodiments.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments.

FIG. 1 is a cross-sectional view of an embodiment of a threaded connection in accordance with certain aspects of the present invention.

FIG. 2 is a cross-sectional view of the pin member of the embodiment shown in FIG. 1.

FIG. 3A is a cross-sectional view of the box member of the embodiment shown in FIG. 1.

FIG. 3B is a cross-sectional view of an alternative embodiment of the box member shown in FIG. 1.

FIG. 4 is a cross-sectional view of a first possible point during the make-up process of the embodiment shown in FIG. 1.

FIG. 5 is a cross-sectional view of a second possible point during the make-up process of the embodiment shown in FIG. 1.

FIG. 6 is a cross-sectional view of a third possible point during the make-up process of the embodiment shown in FIG. 1.

FIG. 7 is a cross-sectional view of a fourth possible point during the make-up process of the embodiment shown in FIG. 1.

FIG. 8 is a cross-sectional view of an alternative embodiment of a threaded connection in accordance with certain aspects of the present invention.

### DETAILED DESCRIPTION

The present disclosure relates generally to a threaded connection comprising a concave circular sealing surface and a convex circular sealing surface, wherein the two sealing surfaces may have different radii. Such a connection can be particularly advantageous for connections which have an indeterminate make-up position, including connections comprising wedge threads.

Although the present disclosure and corresponding claims use the term “circular,” it should be understood that this word is not used to refer exclusively to a surface that is perfectly circular. Rather, “circular” is intended to encompass surfaces that are curved, including but not limited to those that are perfectly circular, substantially circular, or elliptical. Similarly, it should be understood that the words “radii” or “radius” are used to refer to the distance from the center to the outer circumference of a curved surface, regardless of whether that surface is perfectly circular. Thus, for example, if a certain surface is elliptical, rather than perfectly circular, a reference to the “radius” of that surface should be understood to refer to the axis of the corresponding ellipsis.

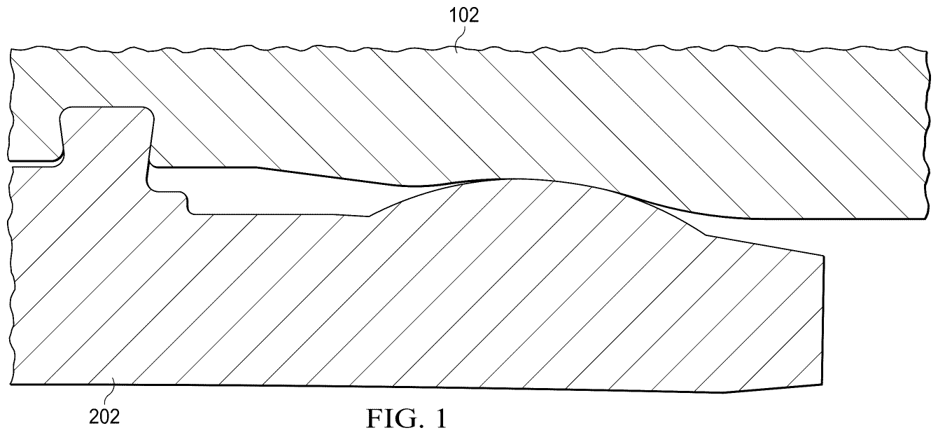

As shown in FIG. 1, an exemplary connection 100 comprises box 102 and pin 202. Box 102 and pin 202 comprise complementary threadforms, such that they are threaded together during make-up.

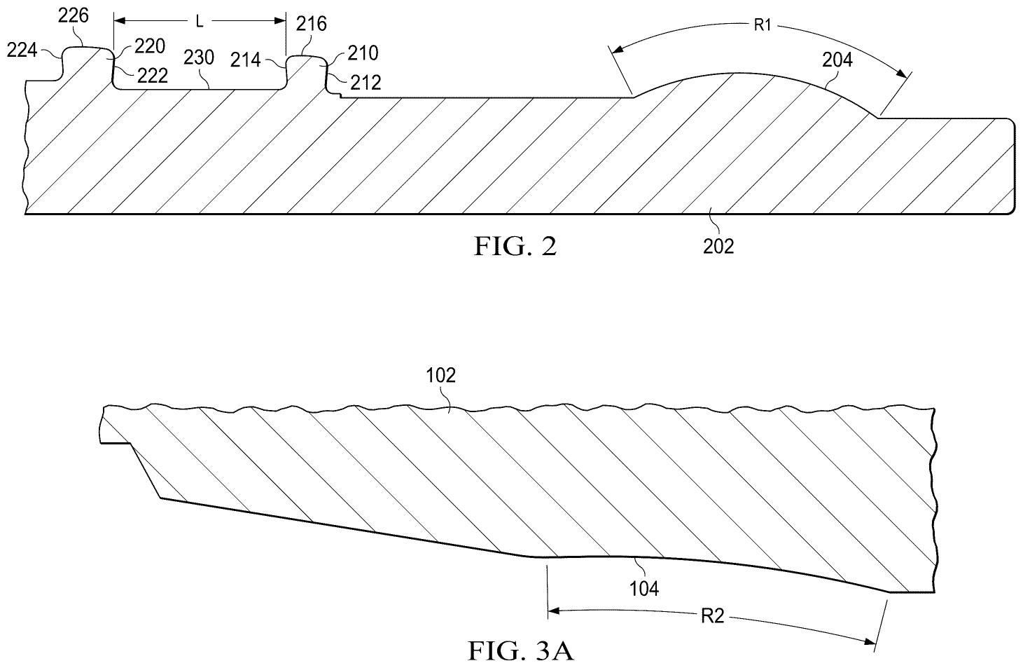

FIG. 2 shows pin 202 comprising individual threads 210 and 220 having, respectively, stab flanks 212 and 222, load flanks 214 and 224, and crests 216 and 226. Threads 210 and 220 are separated by root 230 having a length L. As one of ordinary skill in the art will understand, in a wedge thread configuration, the width of the crests and roots will vary along the length of the threadform. Accordingly, as shown in FIG. 2, thread 220 is wider than thread 210. This progression continues but is not shown in the figures. Wedge threads are well-known in the art and will not be further described herein.

Pin 202 further comprises convex circular sealing surface 204. Convex circular sealing surface 204 has a first seal radius R1. In one embodiment, first seal radius R1 may preferably be within a range of 0.350″ to 1.000″. In another embodiment, first seal radius R1 may preferably be approximately 0.650″.

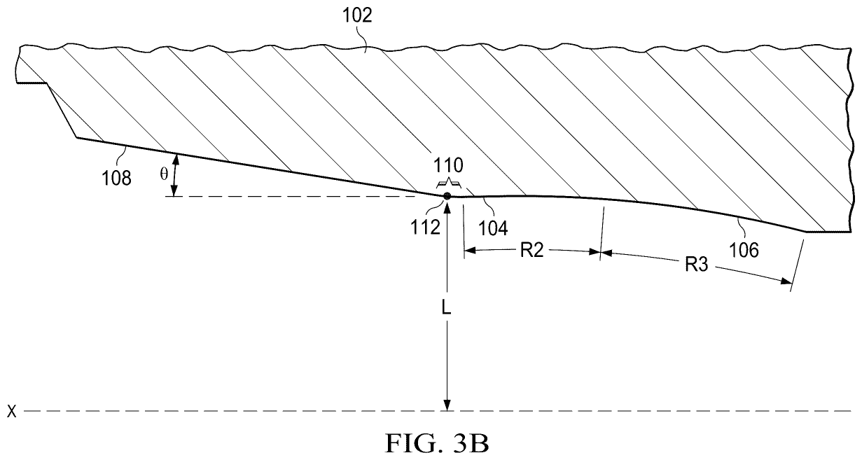

As shown in FIG. 3A, box 102 comprises primary concave circular sealing surface 104. Although not shown in FIG. 3A, one of ordinary skill in the art will understand that box 102 also comprises a threadform that is complementary to the threadform disposed on pin 202.

Primary concave circular sealing surface 104 has a second seal radius R2. In this particular embodiment, second seal radius R2 is different from, and preferably larger than, first seal radius R1. In one embodiment, second seal radius R2 may preferably be within a range of 1.000″ to 3.000″. In another embodiment, second seal radius R2 may preferably be approximately 1.500″.

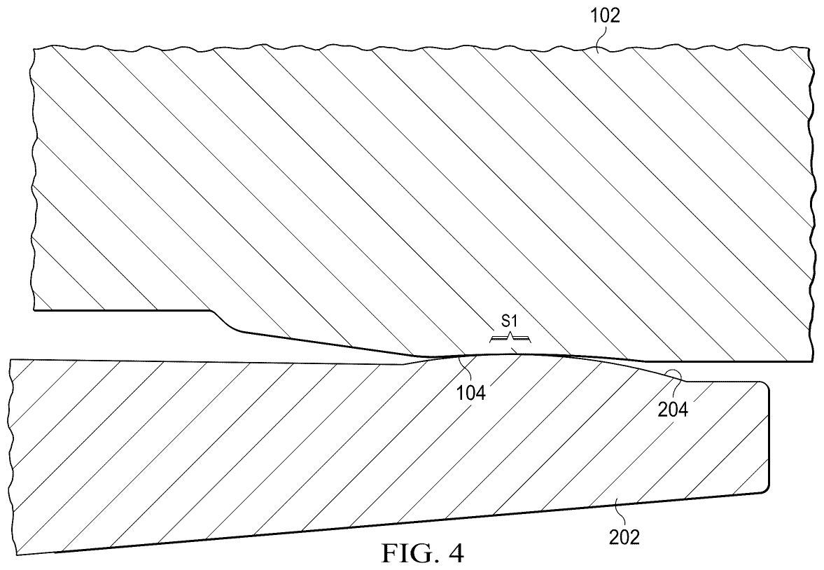

Because second seal radius R2 is different from first seal radius R1, it is ensured that convex circular sealing surface 204 and primary concave circular sealing surface 104 will form a seal over a range of relative axial positions of pin 202 and box 102. For example, at the relative axial location shown in FIG. 4, a seal between convex circular sealing surface 204 and primary concave circular sealing surface 104 is formed over region S1.

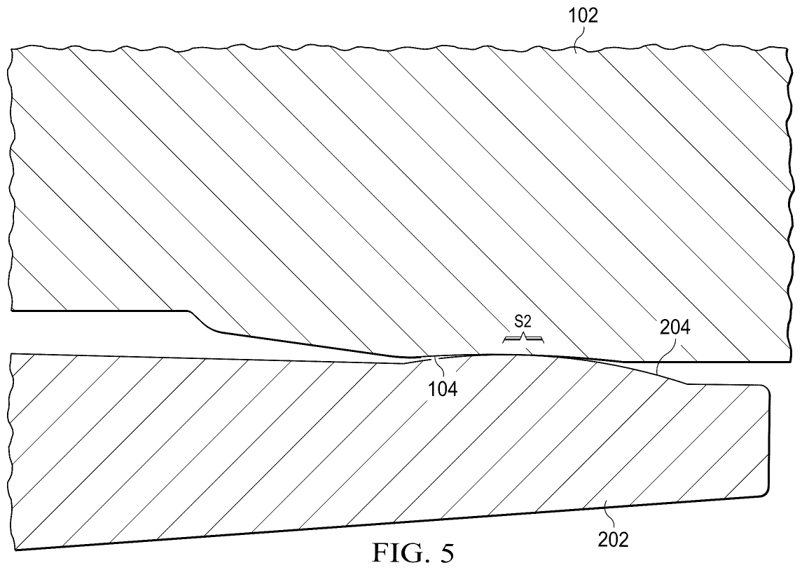

FIG. 5 shows a position at which additional torque has been applied so that pin 202 and box 102 have been further made up to a different relative axial location. At this point, a seal between convex circular sealing surface 204 and primary concave circular sealing surface 104 is formed over region S2, which is shifted to the right in comparison to region S1 shown in FIG. 4.

The configuration of convex circular sealing surface 204 and primary concave circular sealing surface 104 also ensures that a seal is formed regardless of whether the connection is in tension or compression. This bidirectional seal provides a significant performance advantage in comparison to other existing threaded connections.

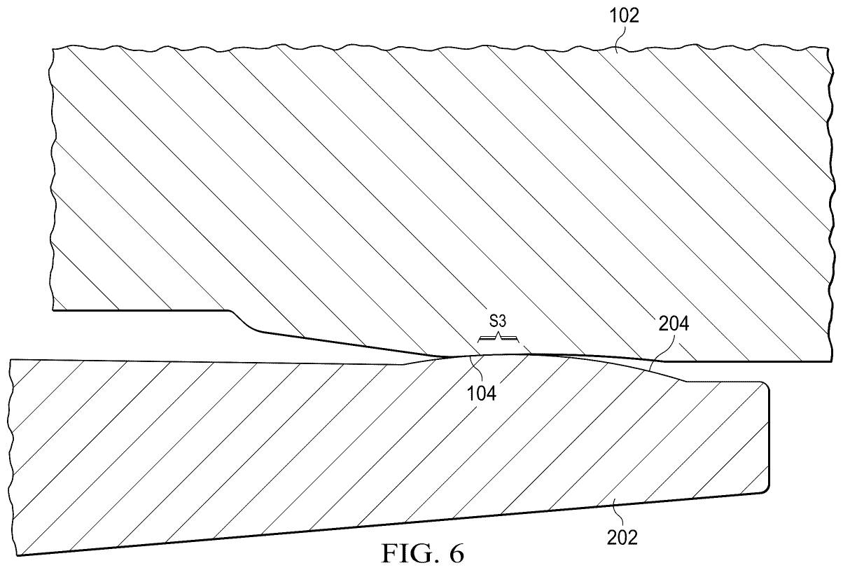

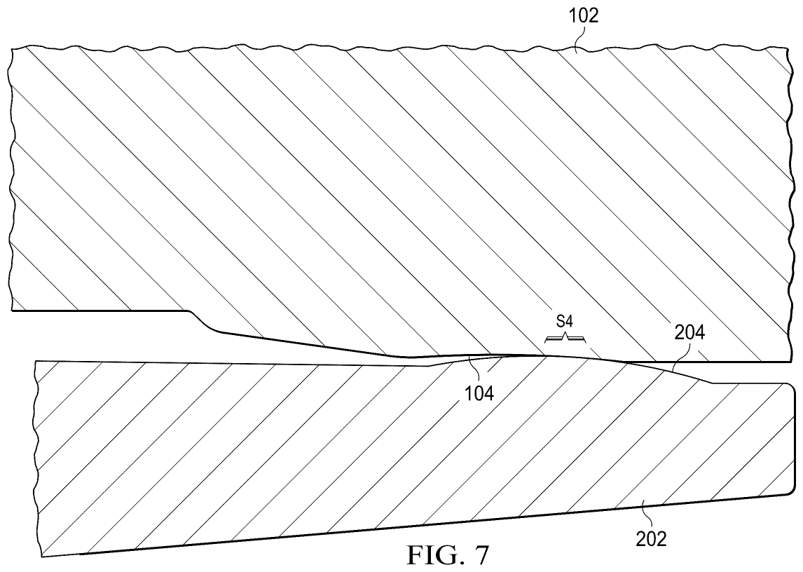

The difference between first seal radius R1 and second seal radius R2 determines the rate of change in interference between convex circular sealing surface 204 and primary concave circular sealing surface 104, as the relative axial positions of box 102 and pin 202 change. The larger the value of second seal radius R2, the smaller the rate of change in interference. The larger the value of first seal radius R1, the larger the rate of change in interference. It has been determined through experimentation that a difference of approximately 0.850″ between second seal radius R2 and first seal radius R1 may create a profile in which the maximum stress on the connection is approximately equal at both extremes of the make-up process, as shown in FIG. 6 (where sealing occurs over region S3) and FIG. 7 (where sealing occurs over region S4).

Although the exemplary embodiment shown in the figures includes a first seal radius R1 that is different than the second seal radius R2, this is not a required feature of the present invention. It is possible, consistent with the invention, that first seal radius R1 could be substantially equal to second seal radius R2.

As shown in FIG. 3B, box 102 may also comprise second concave circular surface 106, and frontside angled surface 108. Second concave circular surface 106 of box 102 may have a third radius R3, which may be smaller than second seal radius R2. In one embodiment, third radius R3 may preferably be within a range of 0.100″ to 1.000″. In another embodiment, third radius R3 may preferably be approximately 0.150″. The ratio between second seal radius R2 and third radius R3 defines the amount of seal geometry available for sealing at the extreme make-up position shown in FIG. 7.

As shown in FIG. 3B, frontside angled surface 108 of box 102 forms an angle θ as measured from the longitudinal axis X of the connection. In one embodiment, angle θ may preferably be within a range of 6° to 10°. In another embodiment, angle θ may preferably be approximately 8°.

As also shown in FIG. 3B, box 102 may also include a transition region 110 between frontside angled surface 108 and primary concave circular sealing surface 104. Transition region 110 may have any geometric configuration, but is preferably a substantially convex surface, in order to minimize the stress that occurs when convex circular sealing surface 204 passes over transition region 110 during make-up. Transition region 110 includes radially innermost point 112, which is at a radial distance L from longitudinal axis X. In this particular embodiment, radial distance L is less than the radial distance from longitudinal axis X to any point within primary concave circular scaling surface 104.

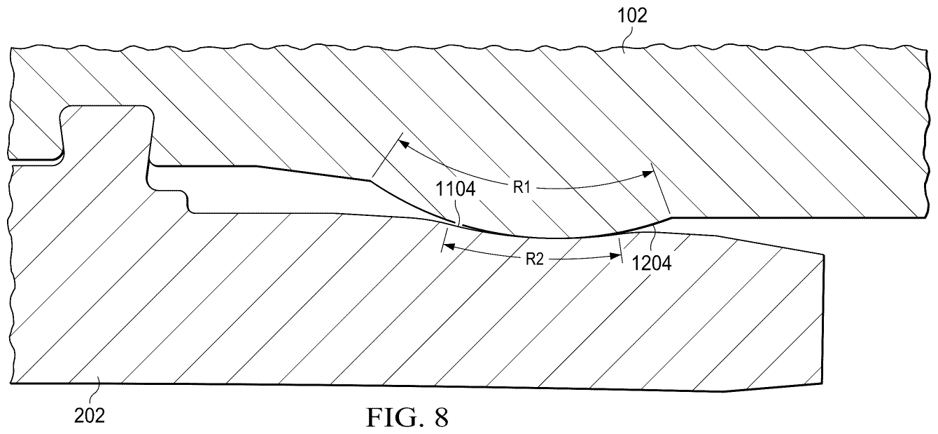

Although the embodiments discussed above show a configuration in which the box 102 comprises a concave sealing surface and the pin 202 comprises a convex sealing surface, one of ordinary skill in the art will understand that the invention is not limited to those particular embodiments. As shown in FIG. 8, this arrangement may be reversed, such that box 102 comprises convex circular sealing surface 1204, while pin 202 comprises primary concave circular sealing surface 1104. Convex circular sealing surface 1204 may have a first seal radius R1. Primary concave circular sealing surface 1104 may have a second seal radius R2. The interaction between convex circular sealing surface 1204 and primary concave circular scaling surface 1104 may be substantially the same as the interaction between convex circular sealing surface 204 and primary concave sealing surface 104 in the embodiments discussed above. Similarly, the relationship between second seal radius R2 and first seal radius R1 may be substantially the same as in the embodiments discussed above. Thus, for example, second seal radius R2 of primary concave circular sealing surface 1104 may be different from, and preferably larger than, first seal radius R1 of convex circular sealing surface 1204.

It is understood that variations may be made in the foregoing without departing from the scope of the present disclosure. In several exemplary embodiments, the elements and teachings of the various illustrative exemplary embodiments may be combined in whole or in part in some or all of the illustrative exemplary embodiments. In addition, one or more of the elements and teachings of the various illustrative exemplary embodiments may be omitted, at least in part, and/or combined, at least in part, with one or more of the other elements and teachings of the various illustrative embodiments.

Any spatial references, such as, for example, “upper,” “lower,” “above,” “below,” “between,” “bottom,” “vertical,” “horizontal,” “angular,” “upwards,” “downwards,” “side-to-side,” “left-to-right,” “right-to-left,” “top-to-bottom,” “bottom-to-top,” “top,” “bottom,” “bottom-up,” “top-down,” etc., are for the purpose of illustration only and do not limit the specific orientation or location of the structure described above.

In several exemplary embodiments, while different steps, processes, and procedures are described as appearing as distinct acts, one or more of the steps, one or more of the processes, and/or one or more of the procedures may also be performed in different orders, simultaneously and/or sequentially. In several exemplary embodiments, the steps, processes, and/or procedures may be merged into one or more steps, processes and/or procedures.

In several exemplary embodiments, one or more of the operational steps in each embodiment may be omitted. Moreover, in some instances, some features of the present disclosure may be employed without a corresponding use of the other features. Moreover, one or more of the above-described embodiments and/or variations may be combined in whole or in part with any one or more of the other above-described embodiments and/or variations.

Although several exemplary embodiments have been described in detail above, the embodiments described are exemplary only and are not limiting, and those skilled in the art will readily appreciate that many other modifications, changes and/or substitutions are possible in the exemplary embodiments without materially departing from the novel teachings and advantages of the present disclosure. Accordingly, all such modifications, changes, and/or substitutions are intended to be included within the scope of this disclosure as defined in the following claims. In the claims, any means-plus-function clauses are intended to cover the structures described herein as performing the recited function and not only structural equivalents, but also equivalent structures. Moreover, it is the express intention of the applicant not to invoke 35 U.S.C. § 112, paragraph 6 for any limitations of any of the claims herein, except for those in which the claim expressly uses the word “means” together with an associated function.

1. A threaded connection comprising:
a first tubular member comprising a convex circular sealing surface with a first seal radius; and
a second tubular member comprising a first concave circular sealing surface with a second seal radius.

2. The threaded connection of claim 1, wherein the first seal radius is different from the second seal radius.

3. The threaded connection of claim 2, wherein the second seal radius is larger than the first seal radius.

4. The threaded connection of claim 3, wherein the ratio between the second seal radius and the first seal radius is greater than 1.0 and less than 3.0.

5. The threaded connection of claim 4, wherein the ratio between the second seal radius and the first seal radius is between 2.0 and 3.0.

6. The threaded connection of claim 2, wherein the difference between the second seal radius and the first seal radius is between approximately 0.4 inches and approximately 1.0 inches.

7. The threaded connection of claim 2, wherein the difference between the second seal radius and the first seal radius is approximately 0.85 inches.

8. The threaded connection of claim 1, wherein the second tubular member further comprises a second concave circular surface with a third radius.

9. The threaded connection of claim 8, wherein the second seal radius is larger than the third radius.

10. The threaded connection of claim 8, wherein the first seal radius is larger than the third radius.

11. The threaded connection of claim 1, wherein the second tubular member further comprises a substantially planar surface that is axially separate from the first concave circular sealing surface and angled with reference to a central longitudinal axis of the connection.

12. The threaded connection of claim 11, wherein the angle between the substantially planar surface and the central longitudinal axis is between 6° and 10°.

13. The threaded connection of claim 1, wherein the first tubular member and second tubular member further comprise wedge threads.

14. The threaded connection of claim 2, wherein the second tubular member further comprises a second concave circular surface with a third radius.

15. The threaded connection of claim 14, wherein the second seal radius is larger than the third radius.

16. The threaded connection of claim 14, wherein the first seal radius is larger than the third radius.

17. The threaded connection of claim 2, wherein the second tubular member further comprises a substantially planar surface that is axially separate from the first concave circular sealing surface and angled with reference to a central longitudinal axis of the connection.

18. The threaded connection of claim 17, wherein the angle between the substantially planar surface and the central longitudinal axis is between 6° and 10°.

19. The threaded connection of claim 2, wherein the first tubular member and second tubular member further comprise wedge threads.

20. The threaded connection of claim 11, wherein the second tubular member further comprises a transition region axially located between the substantially planar surface and the first concave circular sealing surface.

21. The threaded connection of claim 20, wherein the transition region comprises a substantially convex surface.

22. The threaded connection of claim 1, wherein the first tubular member comprises a pin member and the second tubular member comprises a box member.

23. The threaded connection of claim 22, wherein the box member further comprises a transition region axially located between the substantially planar surface and the first concave circular sealing surface.

24. The threaded connection of claim 23, wherein the transition region comprises a substantially convex surface.

25. The threaded connection of claim 24, wherein the substantially convex surface comprises a radially innermost point at a first radial distance from the central longitudinal axis.

26. The threaded connection of claim 25, wherein the first radial distance is less than the radial distance from the central longitudinal axis to any point within the first concave circular sealing surface.

27. The threaded connection of claim 1, wherein the first tubular member comprises a box member and the second tubular member comprises a pin member.
